(19) United States
(12) Patent Application Publication
(10) Pub. No.: US 2025/0131464 A1
(43) Pub. Date: Apr. 24, 2025

(54) SYSTEMS AND METHODS FOR AUTOMATED PROFILES, PREFERENCES, INSIGHTS AND RECOMMENDATIONS BASED ON CONSUMER DATA, UTILIZING ADVANCED TECHNOLOGIES SUCH AS AI

(71) Applicant: Legends Holding Inc., New York, NY (US)

(72) Inventors: Shaina Louise SHIWARSKI, Austin, TX (US); Shashank Jigishkumar PANDYA, San Francisco, CA (US); Stephanie Victoria DANIEL, New York, NY (US)

(73) Assignee: Legends Holding Inc., New York, NY (US)

(21) Appl. No.: 18/800,345

(22) Filed: Aug. 12, 2024

Related U.S. Application Data
(60) Provisional application No. 63/655,372, filed on Jun. 3, 2024.
(60) Provisional application No. 63/532,132, filed on Aug. 11, 2023.

(51) Int. Cl. G06Q 30/0204; G06Q 50/14

(52) U.S. Cl. CPC G06Q 30/0204; G06Q 50/14

(57) ABSTRACT

The present disclosure is directed to systems and methods for preferences and automated profile creation based on consumer data. A system may include one or more processors configured to: collect customer data from external data sources that may represent customer data related a customer preferences such as profile, customer travel history, customer-defined preferences, and/or digital activity; process the customer data and extract customer insights utilizing patterns and preferences identified in the collected customer data using data parsing, mapping statistical analysis, a machine learning algorithm, natural language processing, and/or statistical analysis; and deliver at least a portion of the extracted customer insights to an internal dashboard and/or an external digital platform. The one or more processors may be further configured to generate customer recommendations based on the customer insights and real-time supply and inventory data; and present the customer recommendations on a user interface of a computing device or through brand.

### RELATED APPLICATIONS

The present application claims priority to U.S. Provisional Patent Application No. 63/532,132 (still pending), filed Aug. 11, 2023, and U.S. Provisional Patent Application No. 63/655,372 (still pending), filed Jun. 3, 2024, the entirety of each of which are hereby incorporated by reference.

### FIELD OF THE DISCLOSURE

The present disclosure generally relates to the field of first party and zero-party data management and analytics, and more particularly, to a system and method for capturing, transforming, and translating consumer data and metadata stored or derived from digital sources that may be accessed from a computing device such as a mobile phone, table or personal computer, such as metadata on photos, calendar, browsers and consumer installed applications, enabling a unified digital profile of a consumer, preference sharing, insights, segments, audiences and recommendations for real-time personalization and enhanced customer loyalty programs. One area of applicability is in the Travel and Hospitality industry, which lacks access to real-time zero-party and consumer data. Examples include travel advisors, hotels, loyalty programs, airlines, OTAs, experience platforms and more. Other areas of applicability are cross segment and include Financial Services, e-Commerce, Retail, Real-Estate, Transportation, Design and Fashion.

### BACKGROUND

In today's digital era, businesses rely heavily on consumer data to personalize their offerings and experiences, establish and maintain loyalty, manage resources, and enhance operational efficiency. However, many businesses, especially those in the travel and hospitality industry, struggle with limited access to first-party or zero-party data about their consumers, due to a fragmented and disparate ecosystem of data. This limitation arises because many businesses such as booking platforms, search engines and other tools do not share consumer data across industries or platforms. Privacy considerations, changes in cookies and big tech platform approaches add to the challenging evolving landscape. This leads to a lack of real-time personalization and hindering consumers from viewing all of their data or receiving the personalized experiences they want, and brands from enabling personalized or direct-to-consumer marketing and engagement.

Furthermore, with the proliferation of our digital footprints across the internet and devices including mobile device, tablet and personal computer usage, there is a vast and largely untapped reservoir of first-party data and metadata that could potentially be harnessed for enhancing the way brands engage with their customers. This data can provide valuable insights into consumer behavior and preferences and could pave the way for real-time personalization that is powered by the individual consumer. In turn, creating a mutually beneficial value exchange between individuals and brands to share accurate and up-to-date data, at scale.

Despite the potential of this untapped data, no efficient mechanism currently exists for brands to access or leverage this data in a dynamic way, at scale. Moreover, while consumers may be willing to share certain aspects of their data or metadata with selected brands, privacy and data control concerns make it imperative that any system devised to harness this data must enable consumers to consent or authorize which third-party brands can access their data.

People have been using phones for the last 15 years with metadata being attached to each photo, application and interaction that has been taken, and computers and other digital devices for even longer. Brands may have been leveraging this data to create algorithms and user experiences, but no one has transformed this data into a valuable or monetizable format for consumers to access or visualize in a way they can understand and easily share with the brands and people they want to for their own value exchange.

Therefore, there is a need for a system and method that can capture, transform, and translate existing consumer data stored or derived from digital sources that may be accessed from devices such as their mobile, tablet or personal computer mobile devices into a preference set that can be updated in real-time and shared with authorized brands, thus filling this gap in the current state of the art. Such a system would greatly enhance personalization, improve loyalty management, increase operational efficiency and decrease the cost to acquire data for brands in the travel and hospitality industry, among others.

### SUMMARY OF THE DISCLOSURE

The present invention discloses a method and system for creating a comprehensive digital identity for consumers, derived from various data sources, to facilitate personalized experiences and connections with brands across multiple industries. The data sources may include photos, calendar entries, emails, information from third-party applications (such as Airbnb), banking or other expenditure or purchase information, and manual user inputs. Implementations of the method utilizes advanced technologies such as data parsing, mapping, statistical analysis and may include computer vision, artificial intelligence (AI), machine learning (ML), Retrieval-Augmented Generation (RAG) models, and Large Language Models (LLMs) to analyze these inputs and extract valuable insights into user preferences and behaviors.

Upon obtaining user authorization, implementations of the system accesses zero-party data or first-party data from one or more potential sources including photo metadata, calendar or other personal information. It can rapidly process large volumes of photos and other data, identifying patterns such as travel history, aesthetic tastes, common activities, seasonal travel preferences, lodging preferences, transport trends, brand preferences, restaurants, expenditure, personas, companions, style among others. For example, it can identify a user's preference for modern architecture, regular engagement in activities like surfing or mountain biking, and seasonal travel to specific locations.

The system transforms the collected data into a structured “digital identity,” encapsulating detailed personal preferences and behavioral trends. This digital identity is securely stored and managed in a data repository, accessible via a customizable dashboard or white label or through API integration with third-party systems. A key feature of some forms of the system may be the generation of user interfaces that display the digital identity, which can be tailored for specific companies or individuals. With this detailed preference information, the system may also generate segmentations and audiences for targeted marketing as well as recommendations cross channel.

Implementations of the method employ a token mechanism for secure data sharing, enabling users to control access to their data for various brands and service providers. Computer vision may be applied to interpret visual data, while AI, RAG models, and LLMs may enhance data quality and accuracy. These technologies enable the system to conduct real-time checks, predict future preferences and suggest personalized experiences or products.

Additionally, implementations of the system include intelligent agents powered by AI that could assist consumers directly, or brands in providing timely and relevant responses to consumer inquiries, thereby enhancing customer service and engagement. The digital identity and AI-driven insights also allow brands to better understand and cater to consumer needs, fostering a more personalized and engaging interaction.

Furthermore, the system is offered to brands as an integrated or non-integrated solution available through various delivery methods, including an API, White-Label solution, Web-based plug-in or script. These solutions enable brands to capture data and receive preference profiles, insights, segments and audiences, and may provide personalized recommendations based on their specific supply or inventory, enhancing their ability to tailor offerings to consumer preferences. It should be appreciated that the implementation of the system to receive inputs may be at multiple points of a brand-consumer journey such as in app, web, email, SMS or whatsapp, in person, QR code. It should also be appreciated that the impact or delivery of outputs may also be cross channel, and may be through the brand or directly to consumer.

This comprehensive approach not only personalizes experiences in sectors like travel and hospitality but beyond to additional sectors. It should be understood that while the description herein frequently references travel and TravelDNA the system and method is more broadly applicable. It also creates a marketplace across brands and content where consumers can be matched with brands and content that share or align with their values and preferences. By leveraging advanced technologies such as data parsing, mapping, AI, RAG models, and LLMs, the invention ensures the accuracy and relevance of the digital identity, leading to improved customer experience, satisfaction, loyalty, revenue opportunity and more efficient marketing and consumer-brand interactions across various industries.

### BRIEF DESCRIPTIONS OF THE DRAWINGS

The detailed description is set forth below with reference to the accompanying figures. In the figures, the leftmost digit(s) of a reference number identifies the figure in which the reference number first appears. The use of the same reference numbers in different figures indicates similar or identical items. The systems depicted in accompanying figures are not to scale and components within the figures may be depicted not to scale with each other.

Various implementations of the present disclosure will be understood more fully from the detailed description given below and from the accompanying drawings of various implementations of the disclosure.

FIG. 1 is a flowchart of one form of a method for collecting, storing, transforming, and mapping real-time first-party and zero-party data into shareable travel preferences for brands and third-party systems.

FIG. 2 shows a flowchart where a user's device is accessed through an application, website, or platform. The user's preferences are processed and returned via an API gateway to the application or customer databases.

FIG. 3 The system involves user interaction through a Mobile App and/or Web App, facilitating data collection from potentially various sources, including photo libraries, calendars, email accounts, social media, Airbnb, and other applications or platforms. The data is securely stored and processed, with stages including data cleaning, analysis, feature extraction, and data fusion. The system employs machine learning models for real-time predictions, which are visualized on a dashboard. This comprehensive approach enables efficient data aggregation, processing, and presentation, providing users with actionable insights.

FIG. 4(a) and FIG. 4(b) show a mobile app that personalizes travel experiences by allowing users to grant access to their data (410), creating a customizable “TravelDNA™ wallet” (420, 460, 470) that reflects their travel preferences. This digital identity can be used for authentication in third-party apps (440) and may offer rewards for data sharing (450) and instant personalization.

FIG. 5 illustrates a user interface and geohashing and clustering algorithm (500) that converts latitude and longitude into short strings, enabling image grouping by proximity. It uses a hierarchical clustering method to group images from nearby locations into four levels (510, 520, 530, 540), displaying them as a single pin on the map to enhance user experience and optimize server load.

FIG. 6 depicts the conversion of TravelDNA™ metadata into distinct elements (640), uniquely visualized for an individual (600). These elements are displayed separately (620) and collectively (610) on a personalized “planet,” which dynamically updates, such as with new city visits, illuminating background stars. This globe serves as a digital identifier, which may be represented as an NFT and Soulbound token called the “Travel Soul.”

FIG. 7(a), FIG. 7(b), FIG. 7(c), FIG. 7(d), FIG. 7(e), and FIG. 7(f) illustrate an architecture diagram (700) for efficient Cache Miss handling and accurate visual mapping of pins on a user interface. The system employs Bloom filters and read-through caching to determine the presence of pins, which represent user-visited locations and associated content (730), thereby minimizing database queries. This setup ensures quick response times and precise pin placement based on geographic coordinates, enhancing user interaction with the map view (750).

FIG. 8 presents a dashboard system (800) optimized for web and mobile, providing comprehensive travel insights. It includes a navigation bar (810) for accessing various features, the AI interface DiNA (820) for travel recommendations, and modules for user details (830), geographical visualization (840), travel analytics (850), customer segmentation (860), predictive travel (870), and preference scoring (880). A personalized section (890) delivers tailored marketing recommendations, may use computer vision and may integrate with other platforms such as CRMs, Canva, Facebook and others.

FIG. 9 illustrates a summary dashboard (900) providing preference insights for users and third-party providers. The dashboard features an admin bar (910) for management tasks and an insights bar (920) for metrics and user engagement data. It includes functionalities like audience categorization (940), consumer spending patterns (950), algorithm-driven communication suggestions (960), travel-related geographical data (970), propensity indexing for predicting travel likelihood (980), and demographic visualization (990), offering a comprehensive analytical view for brands.

FIG. 10 showcases the user interface of “Ask DiNA,” an AI-assisted tool for creating personalized travel itineraries. Users and brands can input or sync travel preferences, referred to as “TravelDNA™,” via element 1010. The tool then generates customized itineraries displayed in element 1020, which include destinations and booking details, and can be integrated into a brand's POS system for real-time recommendations based on availability.

FIG. 11 illustrates a scalable system architecture where users (1100) access services through web browsers or devices. Requests are secured via a firewall (1110) and routed to compute servers (1120), which interface with an EKS cluster (1140) balanced by a load balancer. Nodes in the cluster (1150) run microservices that utilize a cache (1160) for fast data access, and the system includes a read database (1170) and a cluster database (1180) for reliable data storage and retrieval.

FIG. 12 depicts a company's server infrastructure, featuring a physical server split into two Virtual Machines (VMs)—1210 and 1220. VM 1210 runs application and API services in containers, while VM 1220 hosts notification and AI services in a similar setup, both managed by a hypervisor (1230) that allocates resources efficiently. A networking layer (1240) connects all components, emphasizing modularity, scalability, and security.

FIG. 13 illustrates a web-based app's user interaction and data processing cycle. Users input data like photos and location (1310, 1320), which is processed using multithreading for fast analysis (1330). The processed data is temporarily stored in RAM (1340) for quick access, with additional local storage for offline use, and results are displayed as insights and visualizations (1350). Wireless modules enable data transfer to external platforms (1360, 1370, 1380), including cloud storage integration, enhancing user experience and privacy.

FIG. 14a and FIG. 14(b) show the process for brands, travel agents, or tour operators using a white-label tool to invite customers to create personalized profiles. It includes receiving custom affiliate links (1411), white-labeling the tool (1412), and distributing custom landing pages (1414), with customers authenticating their data (1415) and receiving tailored information and assistance from an AI agent (1416).

FIG. 15—depicts the user interface (UI) of an application enabling consumers to authenticate and share data sources for creating a personalized profile. The UI allows users to upload and categorize photos (1510-1512), which are processed using proprietary computer vision technology (1513-1515) to generate tags and match them to relevant destinations and brands. Additionally, users can link other data sources like Airbnb and Uber (1516-1517), with the UI providing personalized recommendations for places and activities (1518). Consumers may also add inputs by reacting to suggested images or prompts and the system will translate these inputs or actions into insights and preferences. This may be referred to as gamified or manual process.

FIG. 16—presents an architectural diagram showcasing the integration of various AI processing components within a travel service provider's system.
1600-1618: The system centralizes multiple data sources, including travel documents and images, leveraging AWS infrastructure for secure storage, processing, and analysis. Key components include AWS S3 buckets for staging (1603, 1606), databases for structured and unstructured data (1604, 1605, 1609), and AI tools such as Amazon SageMaker (1611) and Amazon Rekognition (1612) for data and image analysis.
1619-1625: The architecture also includes CI/CD pipelines, monitoring, and API management for efficient deployment and operational support, ensuring a scalable, secure, and responsive system.

FIG. 17—illustrates a user interface for brands to segment customers and build targeted audiences. It includes tools for filtering and identifying users based on various criteria, as well as aggregating data to reveal correlations and overlapping interests among customer segments.

### DETAILED DESCRIPTION OF THE DRAWINGS

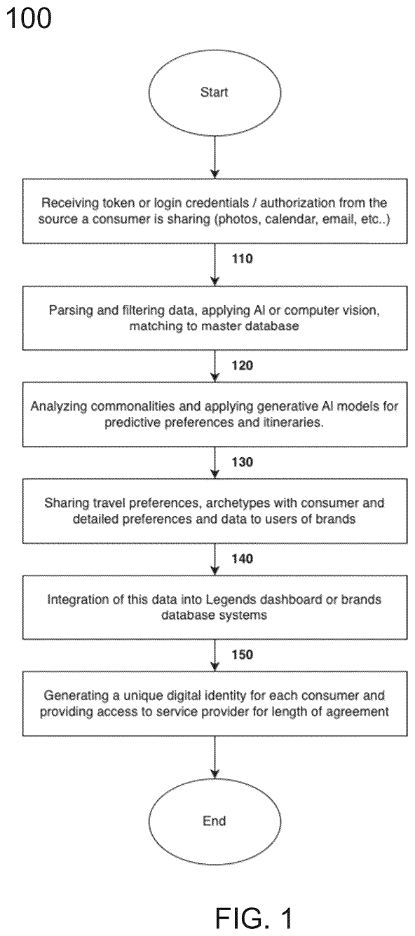

FIG. 1 illustrates a flowchart depicting one form of a process implemented by the system for receiving, processing, and sharing consumer data for generating insights, predictive preferences and recommendations or itineraries. The process involves the following steps:
100—One or more servers at the service provider receive token or login credentials/authorization from consumer devices. This step involves a consumer granting access to their data sources, such as photos, calendars, emails, etc.
110—The servers parse and filter the received data using AI, ML or computer vision techniques. The filtered data is then matched to a master database to identify relevant information and correlations such as patterns and key insights.
120—The servers analyze commonalities within the filtered data and apply generative AI models to improve the consumer experience or brand visualization. This step helps predict preferences and generate personalized itineraries based on the consumer's shared data and ingest brand supply and inventory data to be matched with the profile data.
130—The generated travel preferences and archetypes are shared with the consumer. Additionally, detailed preferences and data are shared with users at brands, providing valuable insights into consumer behavior.
140—The processed data and insights are integrated into the Legends dashboard or the database or systems and tools of partnered brands. This integration ensures that the data is accessible for further analysis and use by authorized parties.
150—A unique digital identity is generated for each consumer based on the analyzed data. This digital identity is used to provide personalized services and access to the service provider's offerings for the duration of the agreement. It should be appreciated that digital identity, segmentations, audiences or recommendations may be delivered to or leveraged by the brand.

Hardware Implementation: Each step in the process is executed by servers at the service provider, equipped with processing circuitry and memory. These servers store and execute the necessary instructions to carry out the described processes. The consumer's phone, or device, running a designated application, initiates the sharing of data and interacts with the service provider's servers, enabling the secure transfer and processing of information. Servers and consumer devices, are integral to the implementation of this technology.

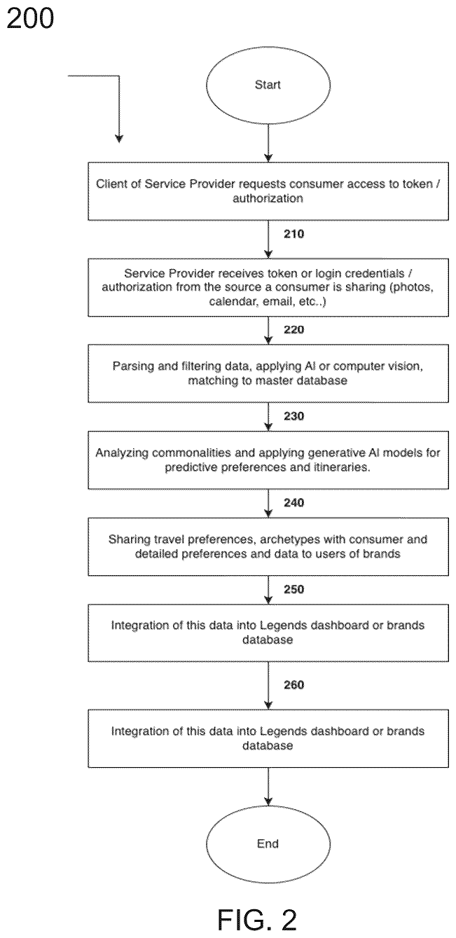

FIG. 2. is a flowchart that describes a method, with similar steps of FIG. 1 but starts with gaining access from the users device through an existing third party consumer application and delivering the value-based preferences back through an API gateway into the third-party consumer application and/or consumer customer databases.
210—is a new step that the consumer provides access to their data source (such as photos, calendar, third-party application) to a brand application (for example consider Marriott Bonvoy) and that brand provides remote access, through a tokenization process to the consumers data via a secure API developed by Service provider and integrated within brand application. This data could be shared to the brand via an API, a browser plug-in, a White Labeled product or website script that is owned or developed by the service provider.

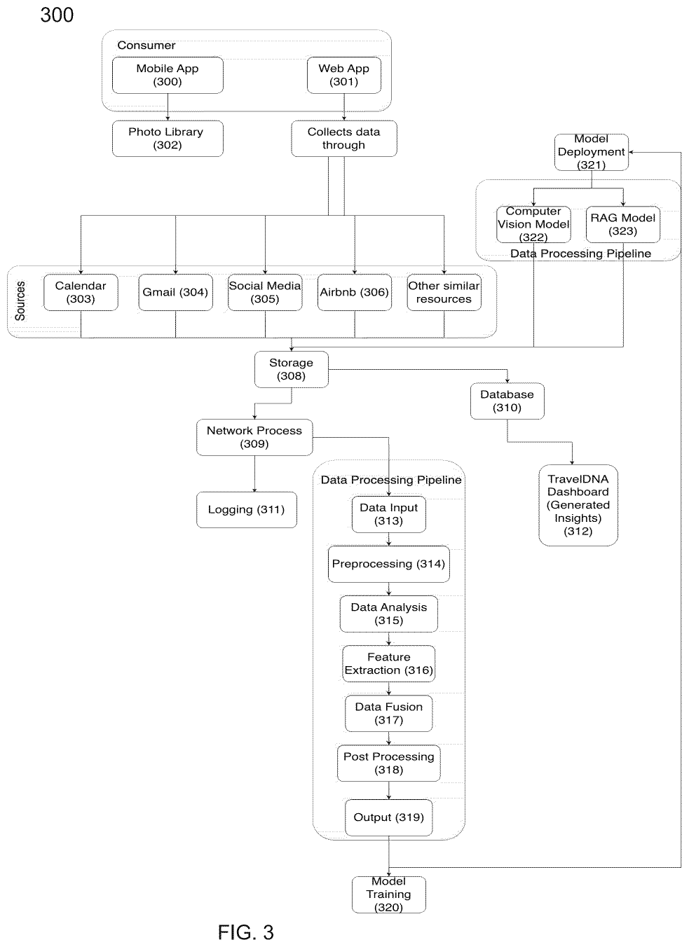

FIG. 3. Is a data processing system comprising a Mobile App (300) and Web App (301) for user interaction, enabling data upload and access. The system includes a photo library module (302) for collecting images and videos from user devices, facilitating data or visual analysis and pattern recognition. It also features a calendar module (303) for extracting event data, appointments, and schedules, to understand user activities and patterns over time. Additionally, the system has an email integration module (304) for retrieving emails, attachments, and metadata from user email accounts, enabling context analysis and extraction of actionable insights. A social media module (305) aggregates data from social media platforms, including posts, check-ins, interactions, and metadata, for analyzing user behavior, preferences, and trends. An accommodation data module (306) collects data related to user stays, reviews, preferences, and booking history from platforms like Airbnb, aiding in understanding user travel patterns and preferences. There is also an additional data aggregation module (307) for compiling data from other platforms and resources, providing a comprehensive view of user activities and interests.

The system includes a centralized storage module (308) for securely storing the collected data, ensuring efficient data management and accessibility for further processing. A network process module (309) facilitates secure and reliable data transmission between system components, while a logging module (311) records system activities for monitoring and troubleshooting. It should be appreciated that the input modules described here are specific examples and the system and method may be applied across multiple inputs including those where consumer reacts to information or manually inputs.

Stored data is organized within a database (310), supporting backend operations with structured storage of user information, processed data, and generated insights. The data processing pipeline begins with a data input stage (313) for receiving raw data, followed by a preprocessing stage (314) for cleaning and transforming data, including removing duplicates, handling missing values, and standardizing formats. The data analysis stage (315) employs statistical methods and algorithms to extract meaningful patterns and trends. Subsequently, a feature extraction stage (316) identifies significant data features crucial for model building. These features are integrated into a comprehensive dataset during the data fusion stage (317). The post-processing stage (318) further refines data quality and usability.

The system utilizes the final processed data for model training (328), training machine learning models such as a computer vision model (322) and a RAG model (323). The model deployment module (321) then deploys these trained models, providing real-time predictions and insights. The TravelDNA™ dashboard (312) visualizes the analyzed data, presenting it to users (consumers and/or brands) through interactive charts, graphs, and other visualizations, enabling informed decision-making.

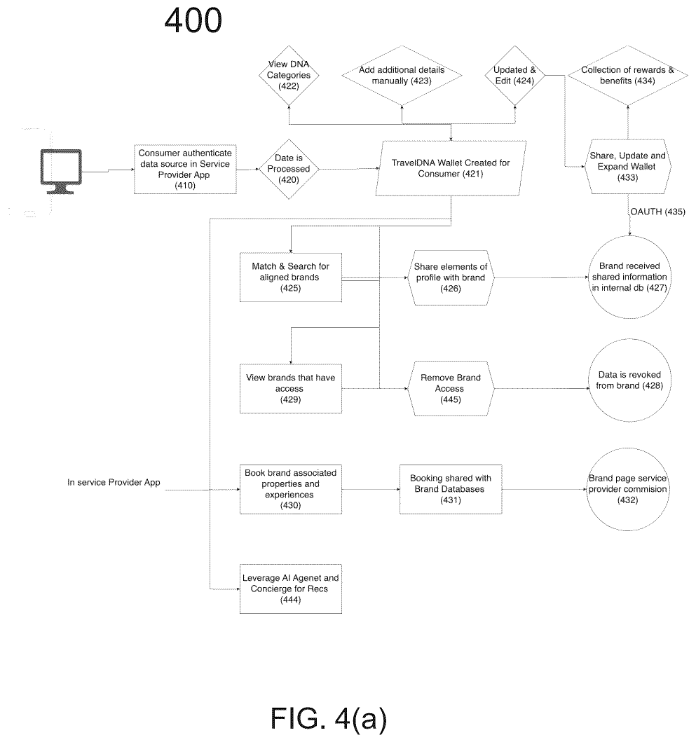

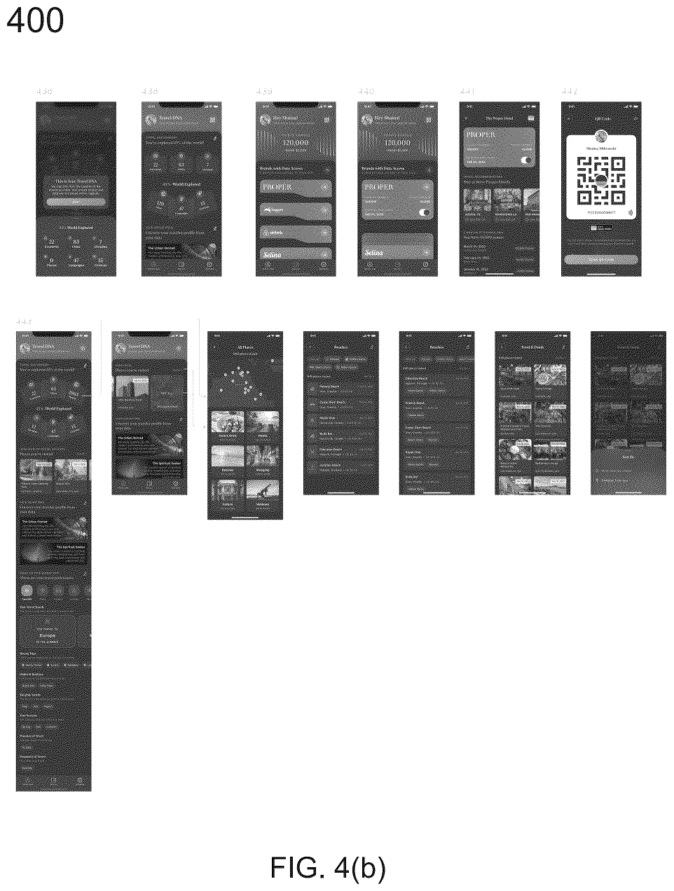

FIG. 4 illustrates a consumer experience in a mobile or web-based application that personalizes travel experiences.
410: The consumer authenticates data sources, such as photos and calendars.
420: The application processes this data into preferences, insights, and recommendations, potentially using AI.
421: A “TravelDNA™ wallet” or “Digital Profile” is created, where consumers can manage their data, connect additional sources, share data with brands, and view personalized recommendations. The wallet includes features like airline and hotel insights (422), manual data input (423), and options to update or edit data (424).

Consumers can share their TravelDNA™ wallet (421) with brands (433), friends, and social platforms. They can also receive benefits and rewards from brands (434). An OAUTH system (435) enables sharing with brands or authenticating on their sites. Consumers can find and select brands to share data with (425) and choose specific profile elements to share (426). Brands receive this data via existing applications, databases, or API integrations (427).

A central app by the service provider allows consumers to view all the brands they are sharing data with (429) and revoke data sharing at any time (445). If data is revoked, it is deleted from the brand's systems (428). Consumers can also book brand services directly within the app (430), with booking details shared with the brand (431), and brands paying a commission to the service provider (432). Additionally, an AI agent and concierge service can provide tailored recommendations for both consumers and brands (444).

Additional user experience elements include:
436: Visual representation of data being calculated from the source.
438: Elements of the profile derived from translating data into insights.
439: E-wallet containing brand cards the consumer shares data with.
440: Example brand card displaying loyalty number and option to toggle data sharing.
441: Brand details and matching services/inventory to the consumer's profile.
442: QR code feature for easy profile sharing.
443: Visual and UI process for using profile insights to explore new places and activities.

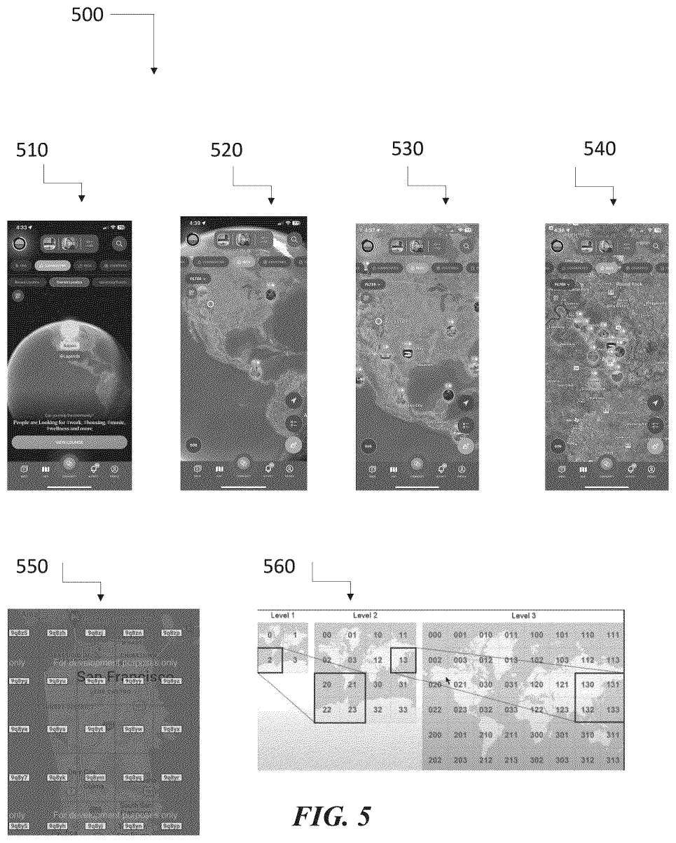

FIG. 5 illustrates a mobile or web-based user experience and details on our geohashing and clustering algorithm 500. We utilize Geohashing, a technique that converts address, text or latitude and longitude data into a short string representation, reference 550 and 560 as an example. This enables us to group images based on their proximity 520, 530, 540. We implement a clustering algorithm that analyzes the geo hashed data and bundles images taken within the same country, state, and city together. This hierarchical clustering approach ensures that images with similar geographic locations are combined 530, providing a clearer view of photo clusters on the map. We have four levels of clustering, level 1 510, level 2 520, level 3 530 and city level 540.

To further enhance accuracy, increase the visual user experience and performance of load balancing for millions of data points, we implement geographic proximity clustering. Images taken within a close range, such as a 50/100 feet diameter, are bundled together as a single pin on the map. This approach reduces the number of individual pins displayed, creating a cleaner and more manageable map experience 520.

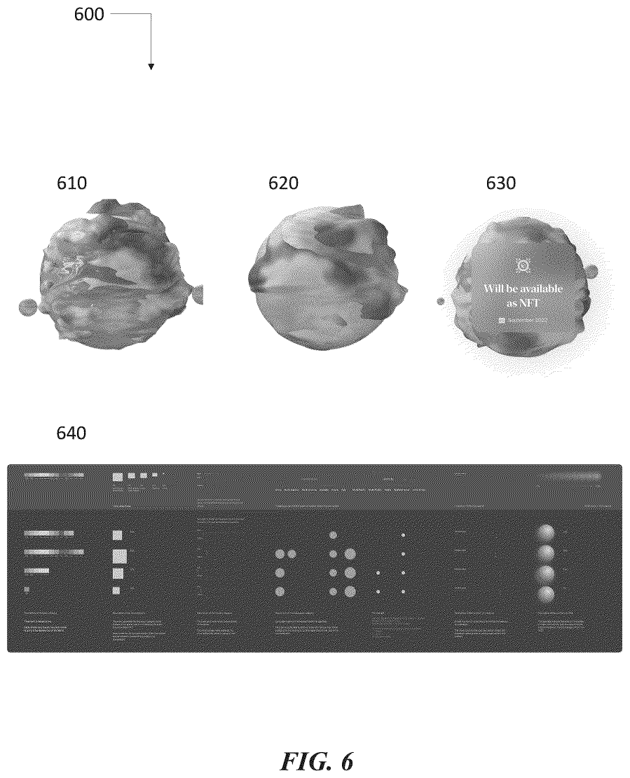

FIG. 6 illustrates translating each datapoint into an element 640 that is represented through a unique visualization for every individual 600. Each piece of data is translated from their TravelDNA™ and converted into a predefined element that represents their own personal earth. We illustrate these elements individually 620 as well as collectively 610 as part of their own unique planet. We are using a hyper-tuning method and algorithm, for example if you go to a new city, the illumination of the stars behind your “Globe” will update and enhance. Every new element will be updated as the data changes. The globe will also be available as a digital identifier as an NFT and or Soulbound token that is represented as their “Travel or Personal Soul”.

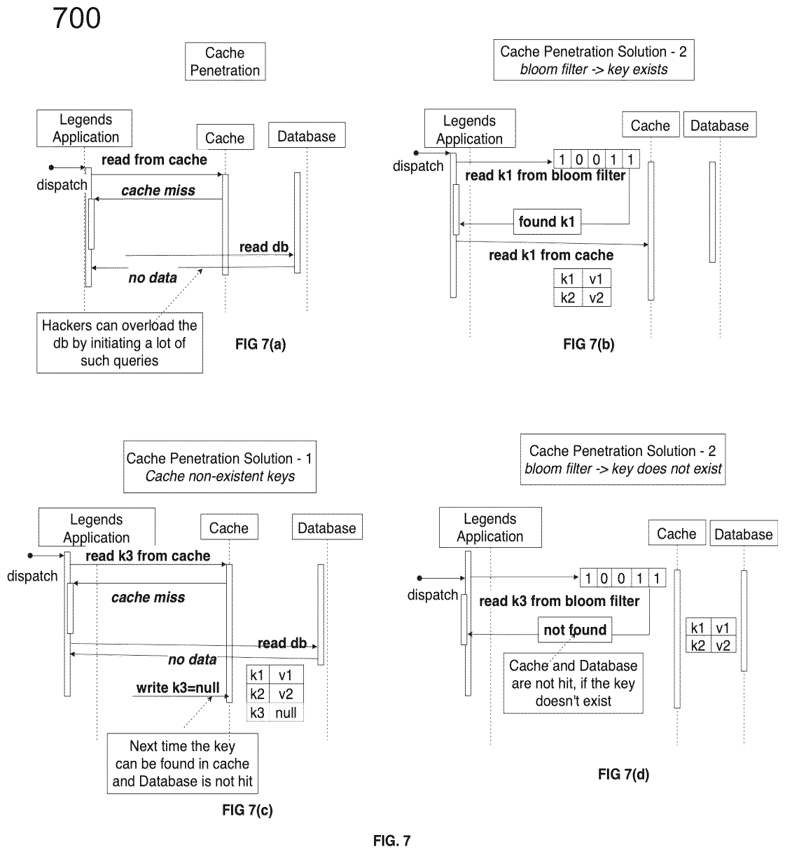

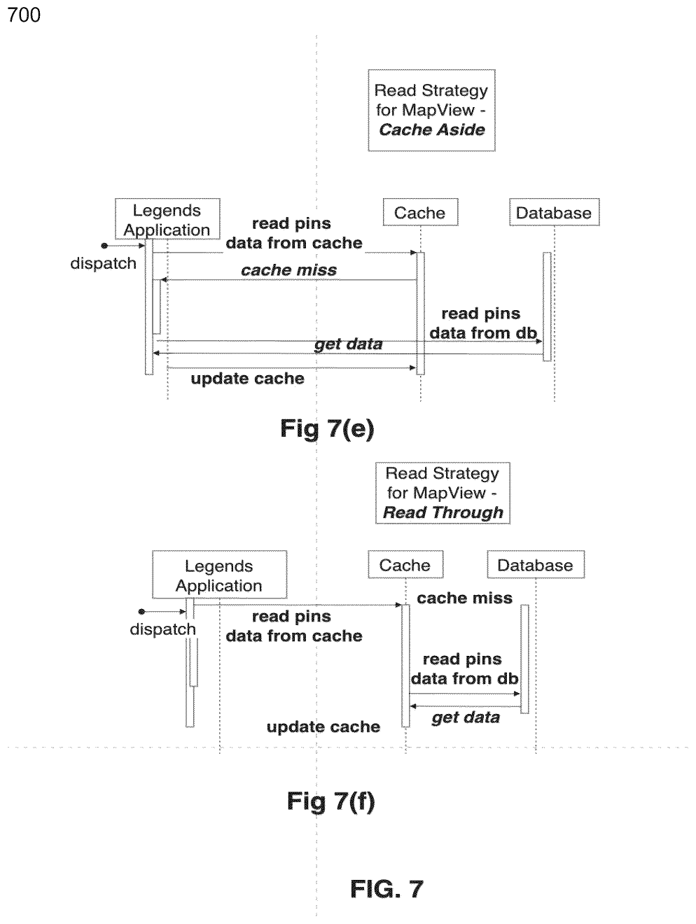

FIG. 7 illustrates an architecture diagram for improving Cache Miss and mapping and clustering of pins visually on a user interface 700. Cache Miss refers to the scenario where data to fetch doesn't exist in the database (in our case it's pins-individual user pins+friends pins) and the data isn't cached either. Many images uploaded by users may lack explicit geolocation data, requiring us to infer the location based on image content, user behavior, and other contextual information. Ensuring accurate location inference becomes critical to providing a reliable geohashing representation. So every request hits the database eventually, defeating the purpose of using a cache. If a malicious user initiates lots of queries with such keys, the database can easily be overloaded. Mapping Pins on Map turned out to be challenging, as millions of data points from users resulted in missing data (pins), non-accurate mapping, data redundancies, etc. 710. The challenge lies in efficiently mapping and displaying pins on a map for both the user and their friends based on the pins' geographic coordinates (latitude and longitude). These pins represent visited places+any added content within the application from the user that is associated to that location 730.

We introduced a solution leveraging bloom filter implementation 720, including certain caching strategies like Bloom filters, read-through caching, and cache-aside techniques. Additionally Bloom filters are leveraged to quickly determine whether a specific location (latitude and longitude) has been visited by the user or their friends 740. The Bloom filter will help determine the presence or absence of pins for a location without needing to fetch detailed pin information. A read through caching algorithm is applied when a user accesses the map view 750, the application checks the cache first to determine if the pins for the requested location are already present 750. If the location is found in the cache, the application displays the pins directly on the map, avoiding the need for a database query. If the location is not in the cache (a cache miss), the read-through caching mechanism is triggered 760. When the cache does not have pins for a specific location, the application uses the Bloom filter to check whether the location has been visited by the user or their friends 760. If the Bloom filter indicates that pins exist, the application performs a database query to fetch the pin information for that location 760. The fetched pin information is then stored in the cache for future access 760. A cache aside technique is applied 760, as the application fetches pin information from the database. The cache is updated with the fetched pin data, associating it with the corresponding location coordinates. This process enables quick filtering of locations where pins might be present, reducing unnecessary database queries. Read-through caching ensures that requested pins are fetched from the database only when they are not present in the cache, improving response times. Cache aside technique ensures that the cache is populated with pin data on-demand, optimizing subsequent map views.

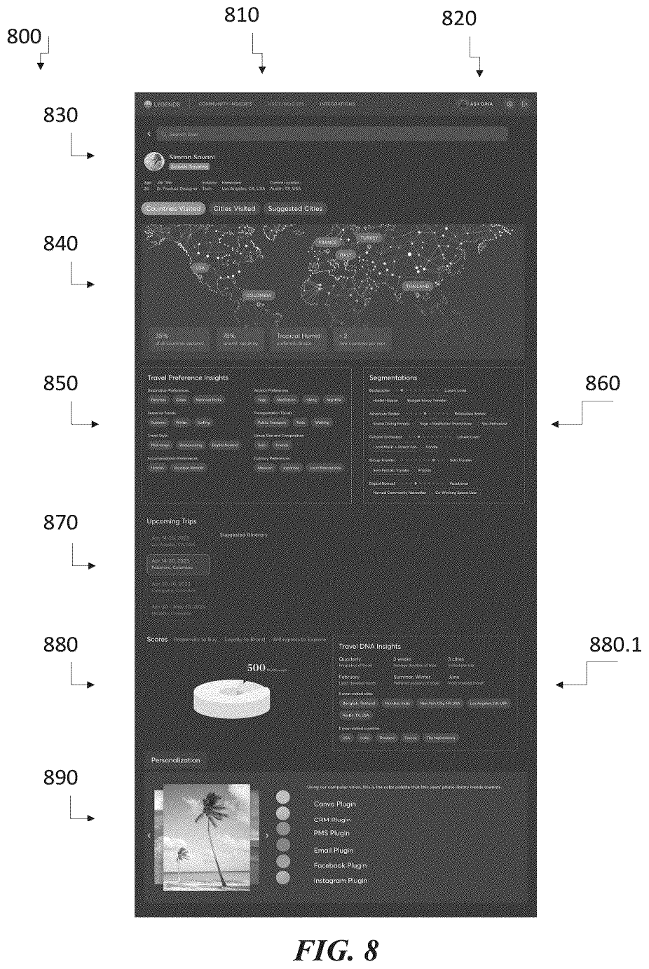

FIG. 8 illustrates a user experience and dashboard system, generally referred to as 800. The dashboard system 800 is designed to be a comprehensive platform for users and third-party brands to gain individual and aggregated insights into users' travel preferences. This system can be accessed via web-based platforms or can adapt responsively on mobile devices. At the top of the dashboard 800, there's a top navigation bar 810. This navigation bar 810 is strategically positioned for easy access and includes several tabs that cater to various functionalities. These tabs are: “Community Insights” that give aggregated insights from the community of users, “User Insights” which provides individualized data points and analytics for each user, “Integrations” which offers an ecosystem of options to integrate third-party tools and platforms to further enhance the functionality of the dashboard. Positioned as part of the navigation bar, there's an interface to interact with an artificial intelligence system named DiNA 820. DiNA 820 is specially programmed to suggest itineraries or places based on a user's historical preferences. This TravelDNA™ is a unique feature that transforms phone metadata into actionable and real-time travel preferences. Adjacent to DiNA's interface 820, the dashboard 800 houses a user detail section 830. This section 830 allows for viewing of all user details en masse or searching specific individual user details. It offers a granular approach to data mining and user behavior analysis. Further enhancing the dashboard's 800 capabilities, there's a geographical visualization module 840. This dynamic module 840 is crafted to allow users to filter and view data based on countries visited, cities toured, and even suggested cities for future visits. Notably, there's a feature that showcases a visual presentation of the planet, highlighting overlaps, patterns, and behaviors of customers. Central to the dashboard 800 is the travel insights generation module 850. This module 850 is a powerhouse of analytics, dissecting and presenting data on a myriad of travel metrics. These metrics include, but are not limited to, destination preferences, seasonal travel patterns, chosen accommodations, activities, and even detailed breakdowns such as culinary choices made during travels. Complementing the insights module 850, there's an automatic segmentation module 860. This module 860 visualizes customer segments based on their unique travel preferences, plotting them on a scale, for instance, from backpacker to luxury traveler. Looking into the future, the dashboard 800 showcases an upcoming travel details section 870. This section 870 is not just a calendar; it's a predictive tool. It proposes itineraries derived from a blend of AI analyses of historical travels and current user preferences. Towards the bottom of the dashboard 800, we encounter a scoring interface 880. This interface 880 offers critical insights into a user's propensity to make a purchase, their loyalty to a particular brand, and their overall willingness to explore new horizons. Nested within the scoring interface, there's a subsection labeled 880.1. This subsection delves deep into individual and aggregate preference insights. It covers a plethora of metrics, from frequency of travel and average trip durations to preferences in seasons and destinations. Finally, the dashboard 800 culminates with a personalization section 890. This cutting-edge section 890 visualizes aesthetic preferences derived from computer vision analysis of users' metadata and photos. Going beyond mere visualization, it also suggests marketing collateral aesthetics and integrates seamlessly with marketing tools such as Canva and Facebook, automating the asset creation process tailored to user preferences. In essence, FIG. 8 showcases a holistic dashboard system 800 that encapsulates the future of travel analytics, preferences, and predictions, bridging users, brands, and destinations like never before.

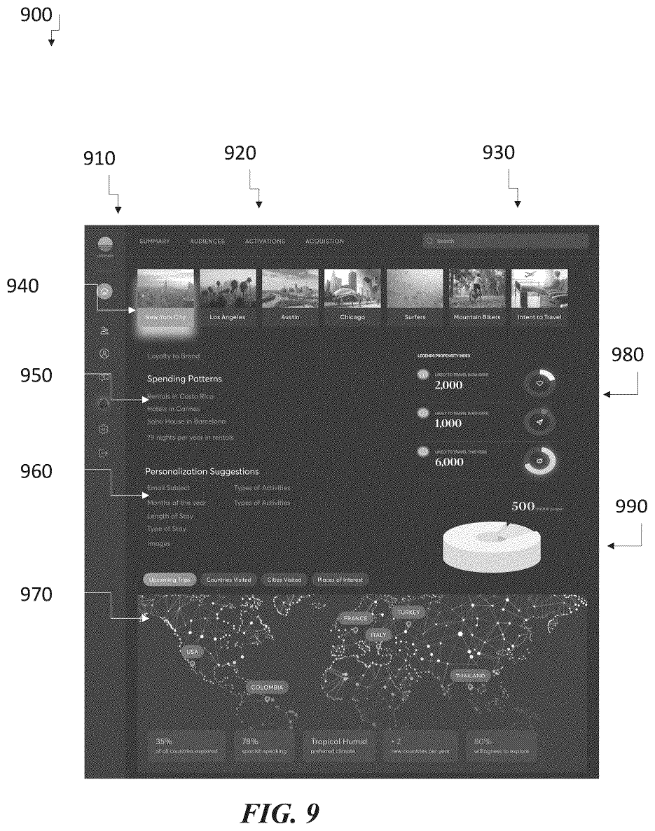

FIG. 9 illustrates a user experience design of a summary dashboard, generally referenced as 900. The dashboard 900 encapsulates the essence of providing preference insights for both individual users and third-party providers who have engaged with the functionalities illustrated in FIG. 1 and FIG. 2. To the left of the dashboard 900, an admin navigation bar is prominently displayed, 910. This navigation bar 910 streamlines management and user experience, with access points including: “Home Screen” for default dashboard view, “User Management” for overseeing user profiles and roles, “Integrations” for managing third-party tool connections, “DiNA” for tapping into the artificial intelligence concierge functionalities, “Settings” for dashboard customization and “Logout” to securely exit the dashboard environment. Gracing the top portion of the dashboard 900, an insights navigation bar stretches across 920. This bar 920 is crafted for ease of access and includes tabs to relay: An “Aggregated Summary” that paints a comprehensive view of key insights encompassing all customers, “Audiences” which hones in on specific user groups or segmentations, “Activations” detailing engagement metrics, “Acquisition” providing insights on user onboarding. A search function is incorporated at the top, enabling users to pinpoint specific insights or individuals with ease 930. The dashboard 900 unravels a myriad of insight modules: Audiences—940: This module introduces both predictive and predefined audience groupings, conceived from the rich tapestry of individual user preference data processed within our learning models. Spending Patterns 950: A profound feature that uncovers spending behaviors deduced from individual metadata, offering brands an unparalleled understanding of consumer habits. Predictive Personalization Suggestions 960: Tailoring communication is pivotal. This segment introduces algorithmically driven suggestions encompassing aspects such as email subjects, optimal months for engagement, anticipated length of stay, and imagery, enhancing brand communication strategies. Geographical Insights 970: At both an aggregate and individual level, this feature unveils critical travel data including current locations of customers, impending trip details, and city visitations over the prior year. Propensity Indexing 980: A hallmark feature, this proprietary indexing mechanism discerns both individuals and user segments based on their likelihood to travel within specific timeframes—30-days, 60-days, or throughout the current year. This adaptability offers brands a foresight to tailor marketing campaigns. Audience Population Visualization 990: To encapsulate audience data in a visual format, this segment dynamically represents the percentage composition of selected audiences in relation to the brand's entire consumer population, offering brands a snapshot of their outreach efficacy. In summation, FIG. 9 meticulously showcases the user experience design for a dashboard 900 that amalgamates data-driven insights and user-centric design, fostering a cohesive environment for brands to gain a granular and holistic understanding of their audience.

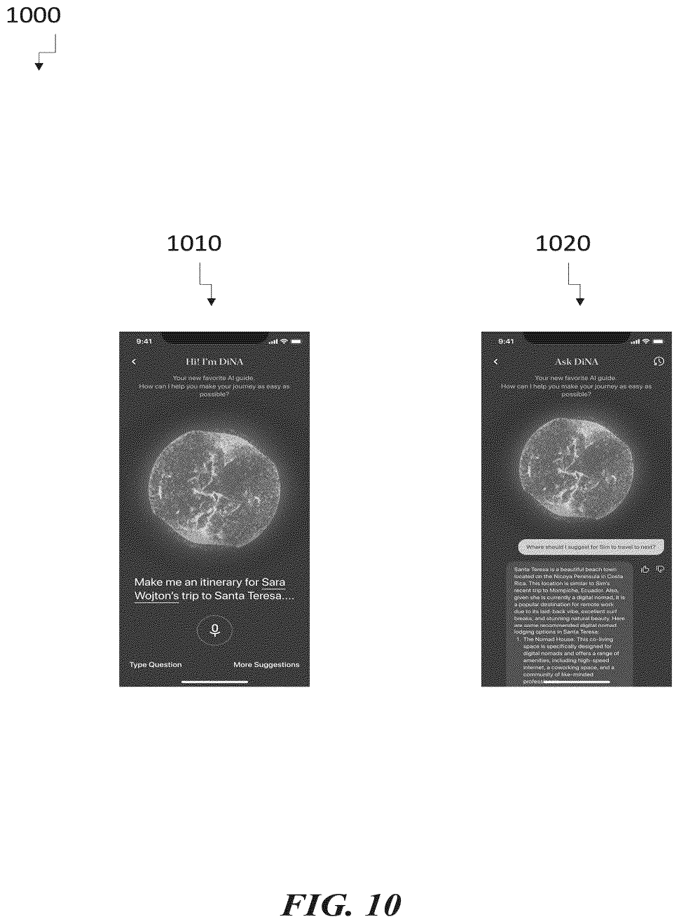

FIG. 10 illustrates an intuitive user experience, showcasing the integrative capacities and functionalities of an AI-assisted tool named “DiNA”. FIG. 10 encompasses two distinctive user experience elements, namely 1010 and 1020, designed to amplify the proficiency of travel itinerary generation based on individuals “TravelDNA™” preferences. 1010 introduces users, be they brands, operators, or individual travelers, to a seamless interface where they can input or sync their distinct “TravelDNA™”. This “TravelDNA™” encompasses intricate travel preferences, past travel history, preferred destinations, accommodation predilections, culinary inclinations, and other nuanced travel-specific data. A hallmark of the “DiNA” AI tool, this segment is designed for ease of use, ensuring that data input or synchronization is straightforward and user-friendly. Whether it's a brand's collective user data or an individual's travel predilections, the system caters to varied scales of input. With the foundation of the “TravelDNA™” set, “DiNA” proceeds to process this data, tapping into its algorithmic prowess to curate the most optimal travel itineraries. Suggested itineraries 1020 are tailored to the embedded “TravelDNA™”. These itineraries are relayed back to the requesting entity, be it a travel agent, brand, or individual traveler. The interface in FIG. 10 is designed for clarity, ensuring users can swiftly comprehend the proposed itineraries, with details like destinations, activities, recommended stays, and booking details. While the example in FIG. 10 illustrates a direct delivery mechanism of these itineraries, “DiNA” boasts adaptive capabilities. It can integrate its suggestions directly into a brand's Point of Sale (POS) system or internal databases. This ensures real-time itinerary suggestions based not just on “TravelDNA™”, but also on real inventory availability-bridging the gap between preference and feasibility.

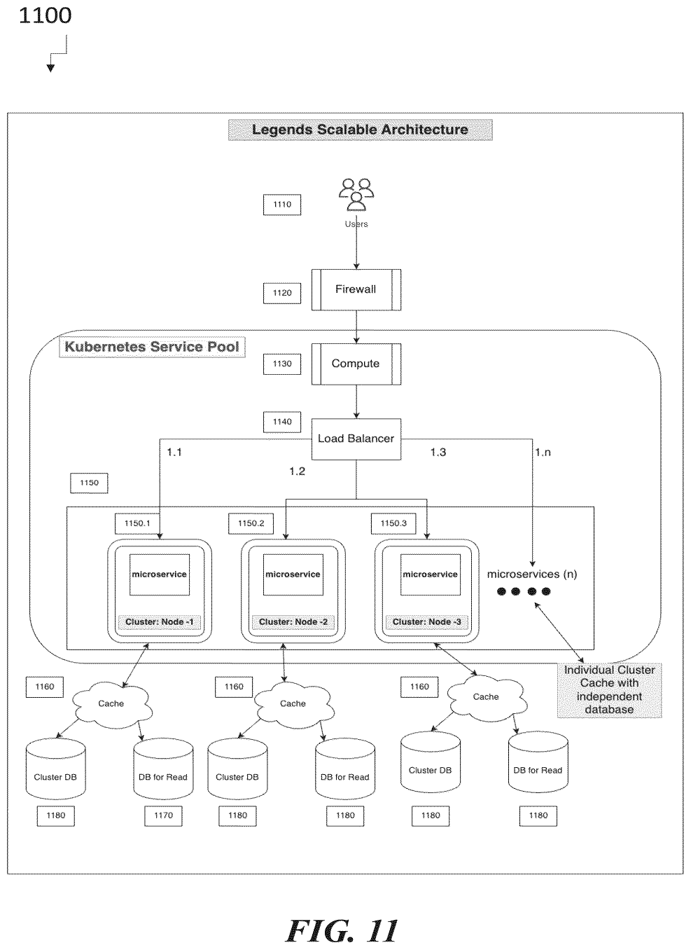

FIG. 11 Illustrates a diagram of our architecture 1100, with the various components communicating with each other in a scalable architecture to ensure smooth operations and efficient interactions. User 1100 interacts with the system through web browsers or devices. User requests are sent to the firewall (1110) for security and access control. The firewall manages incoming and outgoing traffic, enforcing security rules. It ensures only authorized requests proceed to the compute servers (1120) for processing. Compute servers handle user requests and application logic. Upon receiving requests, they interact with the EKS cluster (1140) for distributing workloads. The load balancer 1140 distributes incoming requests across EKS cluster nodes (1150.1, 1150.2, 1150.3, etc.). It provides a platform for deploying, managing, and scaling microservices. Each microservice runs on EKS cluster nodes, serving specific functions. They communicate with each other for seamless collaboration. Microservices use the cache (1160) for quick data retrieval and sharing. The cache 1160 stores frequently accessed data, reducing load on databases. Microservices use the cache for improved performance and efficiency. The read database 1170 stores data primarily used for retrieval. Microservices fetch relevant information from the read database. The cluster database 1180 contains critical and structured data. Microservices write, update, and retrieve data from the cluster database. High availability and data consistency are ensured within the cluster.

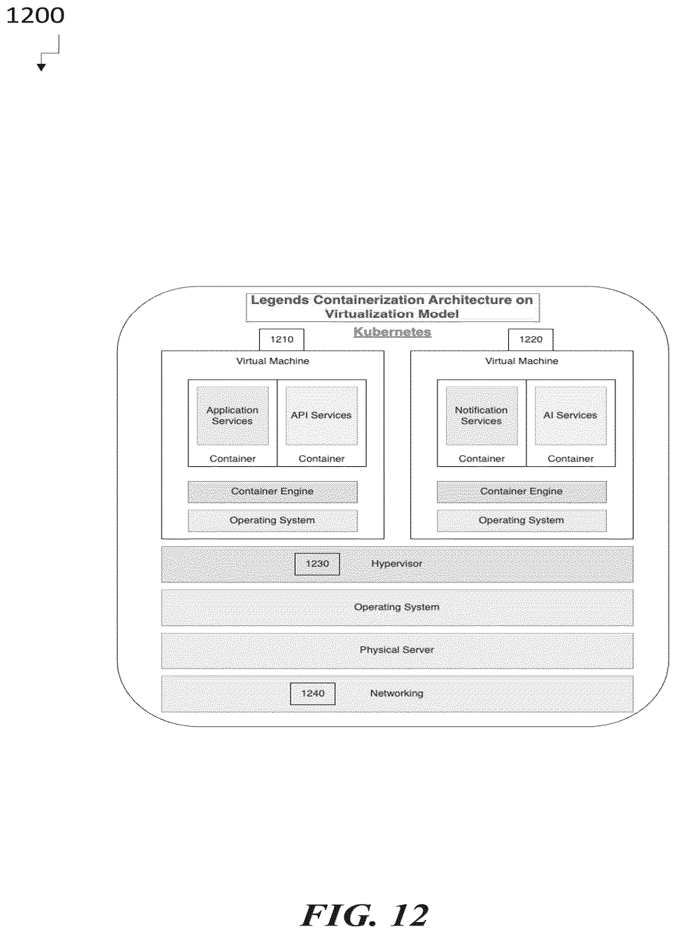

FIG. 12 As a company, we visualize a large foundational block that represents our physical server infrastructure. We've divided this block into two distinct sections, each serving as our Virtual Machine (VM) environment 1210. Inside our first VM, we've allocated dedicated space to encapsulate our application and API services. This VM stands as a self-contained unit replicating an entire operating system (OS) environment. It's adeptly managed by a hypervisor, a layer overseeing and coordinating multiple VMs. Within this VM, we've implemented a container engine that orchestrates the execution of individual containers, neatly containing our application services and API services. Containers, in our scenario, offer a lightweight form of virtualization, allowing us to encapsulate an application and its dependencies. They provide the necessary isolation without introducing the overhead of a full OS since they share the host OS kernel. Containerization empowers us to achieve efficient resource utilization, rapid scaling, and consistent deployment across various environments. In the second VM 1220, we've mirrored a similar structure. This VM proficiently hosts our notification service and AI services, each residing within their dedicated containers. This isolation ensures that our various services can operate independently without mutual interference.

The containers within the VM are orchestrated by the container engine, while the hypervisor manages resource allocation between VMs. This setup ensures required isolation and prevents conflicts among our diverse services. Enveloping our VMs is the hypervisor 1230, a layer abstracting our physical server's hardware resources. It diligently manages the allocation of CPU, memory, storage, and networking for each VM. The hypervisor empowers multiple VMs like ours to operate autonomously on the same physical server, effectively partitioning resources. At the core, we have our physical server hardware and its operating system. The OS collaborates with the hypervisor to ensure optimal resource management and to oversee our VM operations. Our networking layer 1240 ensures the seamless interconnection of all components. It facilitates communication between containers within each VM and supports interactions between different VMs. The hypervisor ensures that each VM's network remains isolated, enhancing security and overall system stability. Both containerization and virtualization are key tools in our quest to optimize resource usage, enhance isolation, and simplify deployment processes. Containers, with their lightweight design and application-specific encapsulation, are instrumental in managing our services efficiently within VMs. Virtualization, with hypervisors as the backbone, abstracts our hardware resources, enabling multiple VMs like ours to coexist harmoniously on a single physical server. This convergence of containerization, virtualization, and networking is integral to our journey towards a modular, scalable, and secure IT infrastructure.

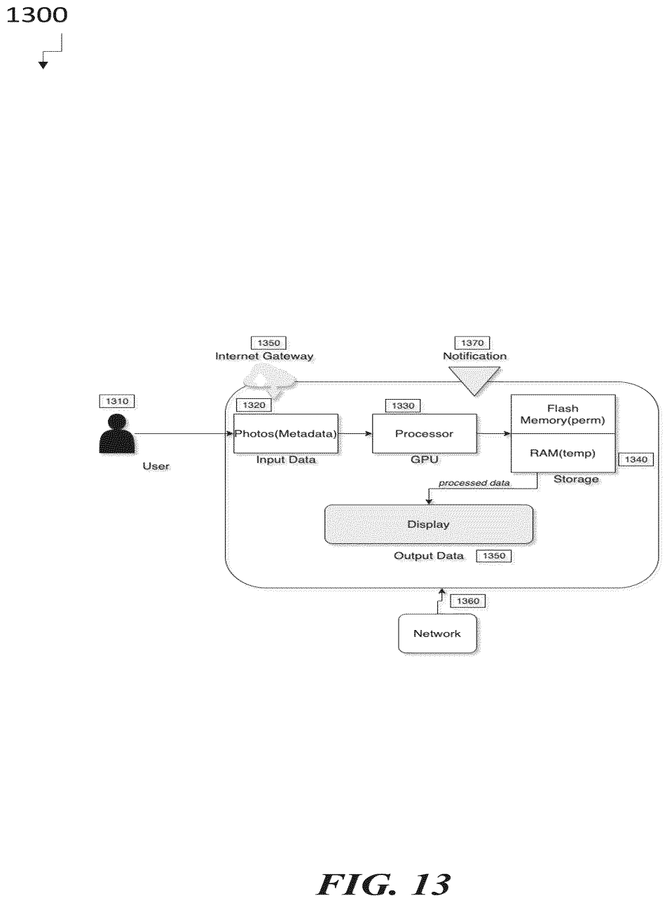

FIG. 13 User Accesses Input Data 1310, 1320: User access the web-based app on their device (e.g., laptop, smartphone). Inputs requested: Photos/metadata, location data, and other relevant information. Data Processing 1330: Processor and GPU: Captured photos undergo processing for analysis and insights generation. Multithreading: Multithreading is employed to parallelize image processing tasks, enhancing efficiency. Storage 1340: RAM: Processed data is temporarily stored in RAM for immediate access during analysis and presentation. Local Storage: A portion of processed data can be stored locally on the user's device for faster retrieval and offline access. Flash Memory: For long-term storage, processed data is stored in flash memory (e.g., SSD) for later use. Presentation 1350: Display: Insights and visualizations derived from the processed data are presented on the user's device display. User Interaction: The user interacts with the presented insights, exploring the analysis results. 1360, 1370, 1380: Wireless Communication: Wi-Fi/Cellular Connectivity: Wireless modules enable internet connectivity for data transfer and interaction with external services. Cloud Services: Processed data might be transferred to cloud-based storage for backup or more in-depth analysis.

Additional Aspects may include: Local Processing: In addition to processing in the backend, some lightweight processing can be done locally on the user's device, contributing to quicker feedback and reducing network dependence; Offline Access: Due to local storage, users can access a subset of insights even when offline, enhancing user experience in areas with limited connectivity; and Data Privacy: Local storage can enhance data privacy by keeping sensitive processed data on the user's device rather than transferring it to external servers.

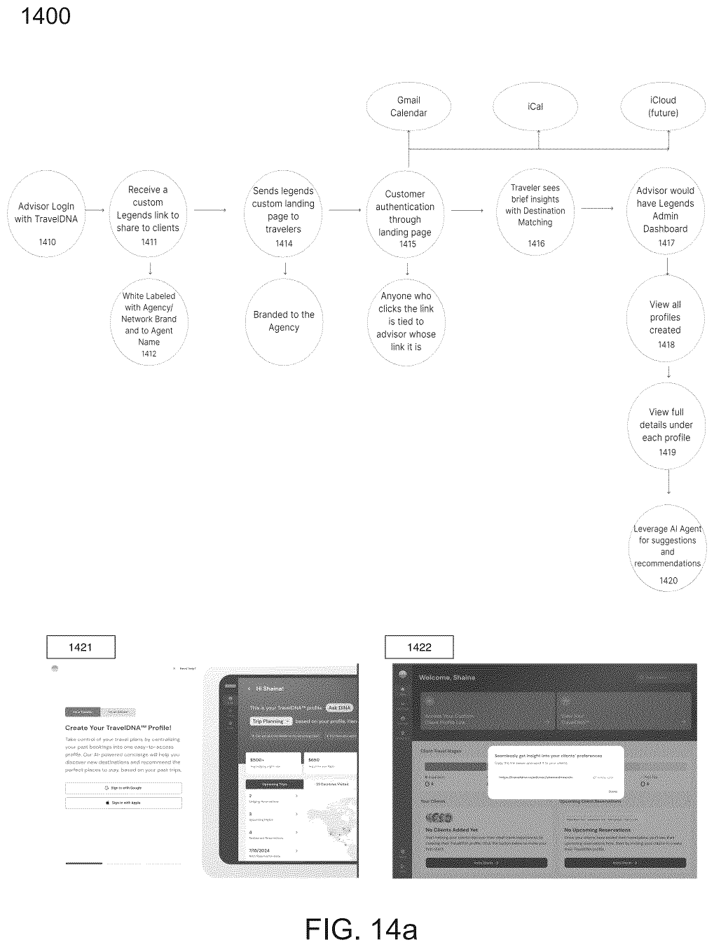

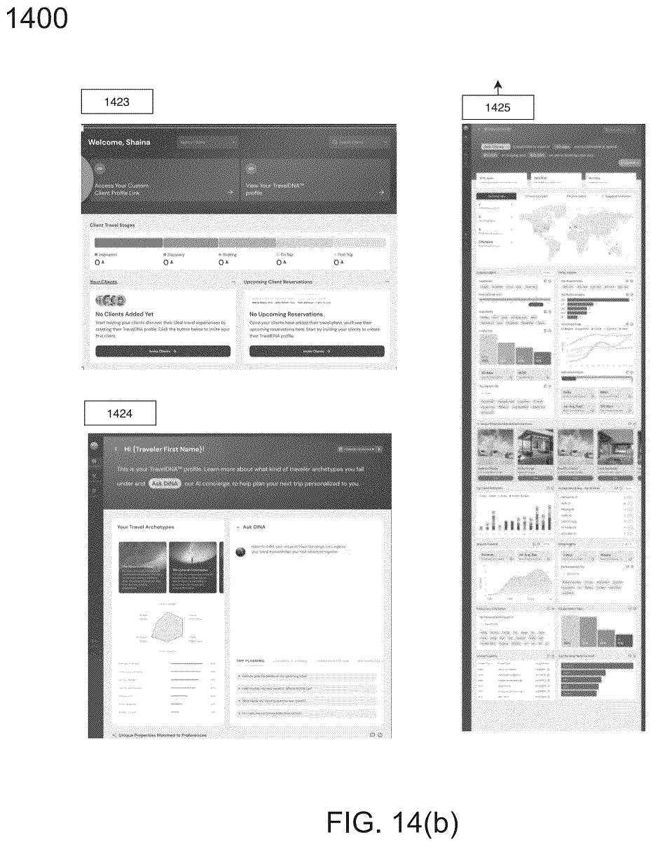

FIG. 14. illustrates the flow for brands, travel agents, or tour operators using a service provider's white-label tool to invite customers to create personalized profiles.

1411: Advisors or individual brand customers receive a custom affiliate link to share with their customers for profile creation.

1412: The tool is white-labeled with the brand's identity.

1414: A custom landing page is sent to brand customers via email, SMS, portal access, or other distribution channels.

1415: Customers authenticate using their preferred data source to create their profile.

1416: Customers receive brief information about their aligned archetype and tastes, with options to use an AI agent for trip planning assistance.

Brand and administrative functionalities:

1417: Brands and admins can view all customer insights in a comprehensive dashboard.

1418: View all profiles created by customers.

1419: Access detailed information under each profile.

1420: Utilize an AI agent to understand customer preferences and optimize marketing strategies.

UI elements include:

1421: Visual representation of the login flow.

1422: UI for the custom link provided to the brand.

1423: UI displaying all customer data and their profile creation stages.

1424: UI showcasing the insights customers see and the AI agent's recommendations.

1425: UI of detailed customer profiles, including data on airlines, flights, reservations, restaurants, activities, loyalty program numbers, and more.

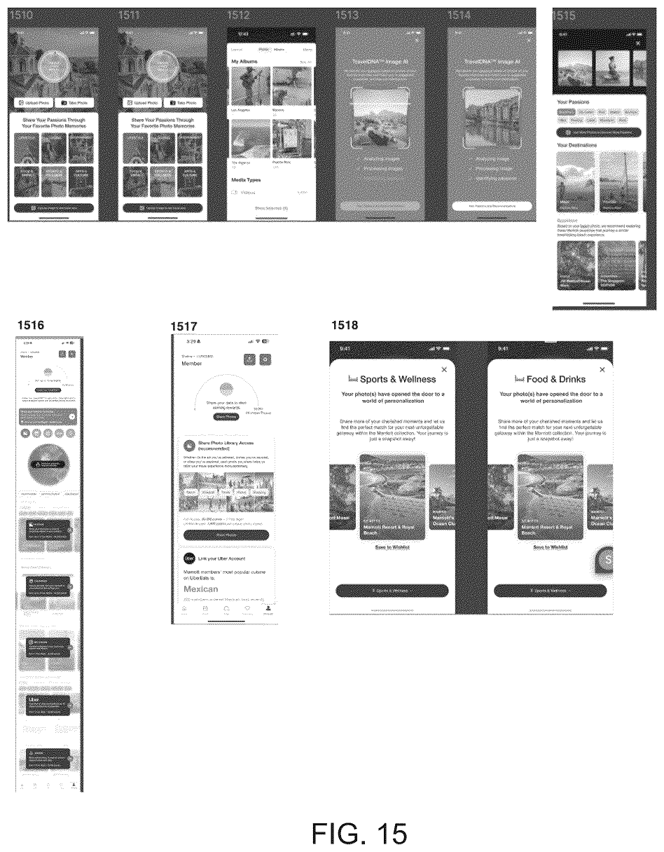

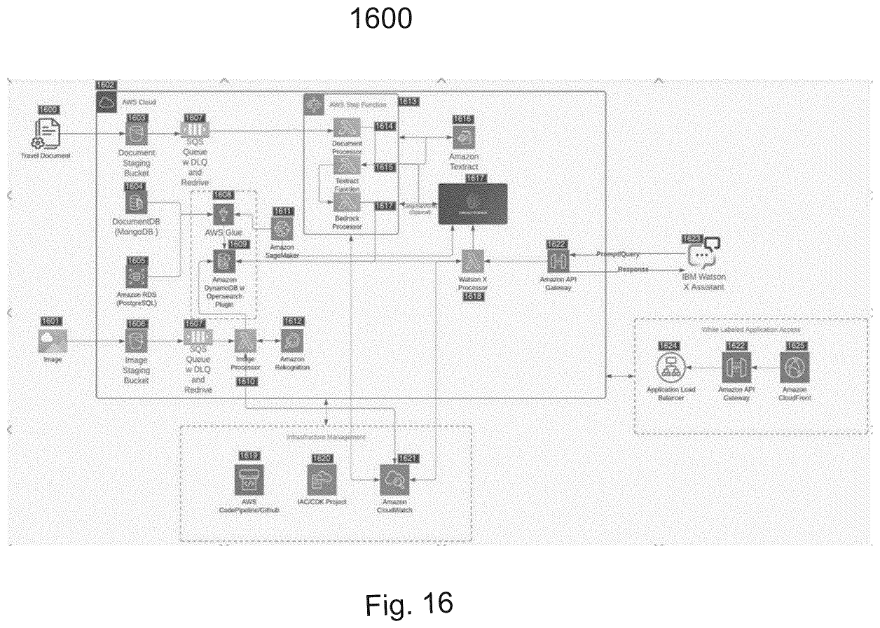

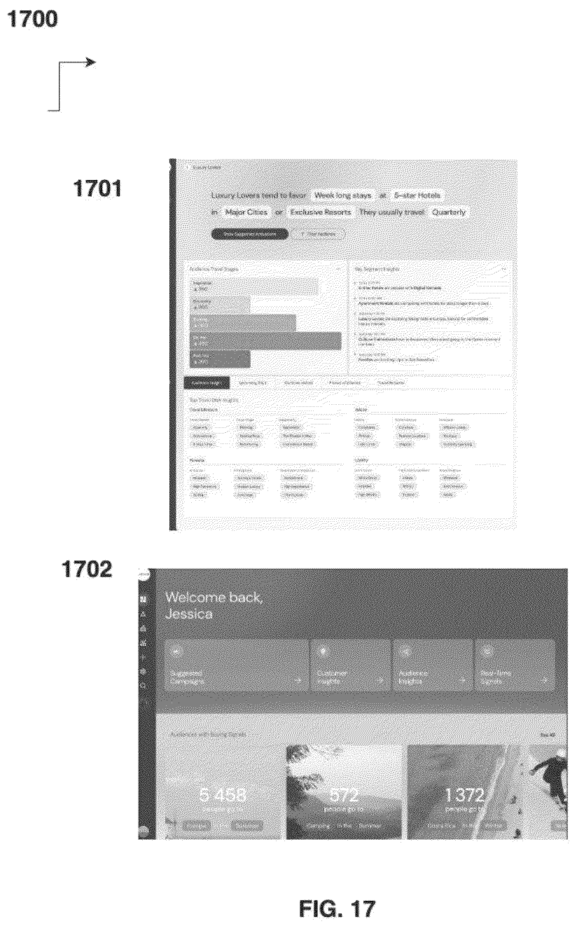

FIG. 15. UI for Data Source Authentication and Profile Mapping-FIG. 15 illustrates the user interface (UI) of a consumer or brand application that allows consumers to authenticate and share data sources for profile mapping. The UI guides users through various steps:

1510: Consumers can start mapping their profile by sharing individual photos, using a computer vision process.

1511: The interface guides them in selecting photos, organizing them by categories.

1512: Users can choose organized photos from their library.

1513: The service provider scans these photos using proprietary computer vision technology.

1514: A processing screen displays the photos being scanned.

1515: The scanned photos are translated into tags and matched to destinations and brands.

1516 & 1517: The UI prompts users to select other data sources, such as Airbnb, Uber, and Calendar.

1518: As the matching process occurs, the UI displays recommendations for places, destinations, and activities.

FIG. 16—Architecture with AI Processing.

1600—Travel Document—Represents text, data, any additional source or information shared by the user. Value: allows for multiple sources and centralized place and organization of data for consumer and brand.

1601—Image Source—Represents the source of images uploaded by users. Value: Captures images that need to be processed for various use cases, such as recognition and analysis, adding visual data processing capabilities to the system.

1602—AWS Cloud—The overall cloud infrastructure provided by Amazon Web Services (AWS), encompassing all the integrated services and resources. Value: Provides a scalable, reliable, and secure environment for deploying and managing the Legends AI Services Architecture. AWS Cloud enables the integration of various services like S3, SQS, Lambda, RDS, DynamoDB, and more, ensuring high availability and performance for the entire system.

1603—Document Staging Bucket—An AWS S3 bucket where travel documents are initially uploaded and stored. Value: Provides a secure and scalable storage solution for incoming documents, facilitating subsequent processing steps.

1604—DocumentDB (MongoDB)—A NoSQL database used for storing unstructured data extracted from documents. Value: Enables efficient storage and retrieval of unstructured data, enhancing the system's capability to handle diverse document formats and contents.

1605—Amazon RDS (PostgreSQL)—A relational database service used for storing structured data extracted from documents. Value: Provides a reliable and scalable solution for managing structured data, ensuring data integrity and supporting complex queries.

1606—Image Staging Bucket—An AWS S3 bucket for storing images uploaded by users. Value: Facilitates the initial storage and organization of images, preparing them for processing and analysis.

1607—SQS Queue with DLQ and Redrive (Documents and Images)—AWS SQS queues that manage incoming document and image processing requests, with support for dead-letter queues (DLQ) and message redriving. Value: Ensures reliable and scalable message handling for processing requests, enabling fault-tolerant and efficient workflows.

1608—AWS Glue—A fully managed ETL service that prepares and transforms data for analytics. Value: Automates data extraction, transformation, and loading processes, enabling seamless integration and preparation of data for further analysis and storage in Amazon DynamoDB.

1609—Amazon DynamoDB with OpenSearch Plugin—A NoSQL database service with integrated search capabilities provided by OpenSearch. Value: Provides high-performance, scalable storage and retrieval of processed document data, enabling efficient search and access to large datasets.

1610—Image Processor—An AWS Lambda function that processes images, including format conversion and preparation for analysis. Value: Handles image preprocessing tasks, ensuring images are correctly formatted and ready for analysis by Amazon Rekognition.

1611—Amazon SageMaker—A machine learning service for building, training, and deploying models. Value: Enables advanced data processing and model inference, supporting AI-driven analysis and insights from the data.

1612—Amazon Rekognition—A service for image and video analysis that detects objects, scenes, and activities. Value: Provides powerful image recognition capabilities, allowing the system to analyze visual content and extract meaningful information.

1613—AWS Step Function—Orchestrates the execution of multiple AWS Lambda functions for document processing. Value: Manages the sequential execution of processing tasks, ensuring a streamlined and efficient document processing workflow.

1614—Document Processor—An AWS Lambda function within the Step Function that performs initial document processing. Value: Handles the first stage of document processing, preparing documents for further analysis and extraction.

1615—Textract Function—An AWS Lambda function within the Step Function that uses Amazon Textract to extract text and data from documents. Value: Automates the extraction of text and structured data from documents, enabling detailed analysis and data extraction.

1616—Amazon Textract—A service that automatically extracts text and data from scanned documents. Value: Provides automated text and data extraction capabilities, crucial for processing large volumes of documents efficiently.

1617—Amazon Bedrock—A service for deploying foundation models for generative AI, optionally integrated into the processing workflow. Value: Enhances the system's ability to perform advanced AI-driven analysis and model deployment, supporting complex data processing tasks.

1618—Watson X Processor—An integration point for IBM Watson X Assistant, providing advanced conversational AI capabilities. Value: Enables the system to process and respond to user queries using conversational AI, enhancing user interaction and support.

1619—AWS CodePipeline/GitHub—Manages the CI/CD pipeline for application deployment. Value: Ensures efficient and automated deployment of code updates, supporting continuous integration and delivery practices.

1620—IAC/CDK Project—Infrastructure as Code (IAC) project using AWS Cloud Development Kit (CDK) for managing AWS resources. Value: Automates the provisioning and management of AWS infrastructure, ensuring consistency and scalability.

1621—Amazon CloudWatch—A monitoring and logging service for tracking the performance and health of the application. Value: Provides real-time insights into system performance and operational metrics, enabling proactive management and troubleshooting.

1622—Amazon API Gateway—A managed service for creating and managing APIs, with two instances: one for general API management and one for white-labeled application access. Value: Manages API requests efficiently, providing features like rate limiting, caching, and authorization, and ensuring secure and scalable access to backend services.

1623—IBM Watson X Assistant—Provides advanced conversational AI capabilities, integrated with the system for handling user queries. Value: Enhances user interaction by enabling conversational interfaces, improving user experience and support.

1624—Application Load Balancer—Distributes incoming application traffic across multiple targets to ensure high availability and reliability. Value: Balances load efficiently, preventing overload on individual resources and ensuring the system remains responsive under varying load conditions.

1625—Amazon CloudFront—A content delivery network (CDN) that securely delivers data, videos, applications, and APIs to customers globally with low latency. Value: Ensures fast and reliable delivery of content to users, improving performance and user experience for distributed applications.

In some implementations, hardware utilized may include a CPU such as an 11th Gen Intel CPU or Zen4-based AMD CPU. CPUs such as these provide: AVX512 Support: Accelerates matrix multiplication operations crucial for AI model inference; Instruction Set Features: More critical than core counts for AI workloads; and DDR5 Support: Provides increased memory bandwidth, essential for high-performance computing. Additionally, the hardware may support 16 GB of RAM to support: AI Model Requirements: Sufficient for running models around 7B parameters; and Performance: Enough for running smaller models comfortably and managing larger ones with caution.

Further, hardware utilized may provide 50 GB of Disk Space to provide storage for: Docker Containers: Accommodates the size of Docker containers (e.g., around 2 GB+ for openAI/ollama-webui); and Model Files: Provides ample space for storing various AI model files.

Hardware utilized may additionally include a GPU that is enhanced for model inference performance. The GPU may support

VRAM Requirements such as: FP16 Models: A 7B model at FP16 might require around 26 GB of VRAM, exceeding many consumer-grade GPU capacities and Quantized Models: GPUs that support 4-bit quantized formats can handle large models more efficiently: 7B Model: ˜ 4 GB VRAM, 13B Model: ˜ 8 GB VRAM, 30B Model: ˜ 16 GB VRAM, and 65B Model: ˜ 32 GB VRAM.

### Technical Challenges

### Efficient Data Handling and High Availability

Challenge: Managing a large dataset with over 9 million records while ensuring high availability and performance.
Solution: Amazon RDS for PostgreSQL: Utilized for structured data storage, configured with read replicas to handle high read loads and automated backups to ensure data redundancy and high availability. Elasticache Redis: Implemented for caching frequently accessed data, which reduces database load and significantly improves query performance.

### Technical Details

Amazon RDS Configuration: Instance Type: db.m5.large (2 vCPUs, 8 GB RAM). Read Replicas: Configured to scale read operations and enhance performance. Automated Backups: Ensures data is backed up daily with a retention period of 7 days.

Elasticache Redis Configuration: Node Type: cache.r6g.large (2 vCPUs, 13.07 GB RAM). Cluster Configuration: Single-node cluster for simplicity and cost-efficiency.

Benefits: High Availability: Ensures continuous availability of the database with minimal downtime. Performance Optimization: Reduces latency and improves response times by offloading read operations to replicas and using in-memory caching.

### Scalable Microservices Architecture

Challenge: Orchestrating multiple microservices efficiently in a scalable environment.

Solution: AWS ECS with Docker Containers: Used to deploy and manage microservices. ECS provides isolated environments for each service, while Docker containers ensure consistent and reliable deployments. Horizontal Scaling: ECS manages container deployment, scaling, and management, allowing the system to scale horizontally based on demand.

### Technical Details

AWS ECS Configuration: Cluster Type: EC2 launch type for more control over the underlying instances. Instance Type: c5.large (2 vCPUs, 4 GB RAM). Auto Scaling: Configured with target tracking policies based on CPU and memory utilization.

Docker Configuration: Image Repository: Amazon ECR for storing and managing Docker images. Container Definition: JSON-based configuration defining the resources and environment variables for each container.

Benefits: Isolation and Fault Tolerance: Each microservice runs in its own container, ensuring isolation and reducing the risk of failure propagation. Scalability: Automatically scales the number of running instances based on real-time demand, ensuring optimal resource utilization.

### Secure and Efficient API Management

Challenge: Providing a robust and secure API service capable of handling high volumes of requests.

Solution: API Gateway: Manages API requests, providing features such as rate limiting, caching, and authorization. AWS Lambda: Enables real-time data processing without the need for dedicated servers, ensuring scalability and cost efficiency. AWS WAF and Cognito: Ensures API security and user authentication, protecting the system from common web threats and unauthorized access.

### Technical Details

API Gateway Configuration: Rate Limiting: Configured to prevent abuse and ensure fair usage. Caching: Enabled for common API responses to reduce latency and improve performance. Authorization: Integrated with AWS Cognito for user authentication.

AWS Lambda Configuration: Function Memory Size: 512 MB to 3 GB based on the processing requirement. Timeout: Set to 30 seconds to handle complex processing tasks.

AWS WAF Configuration: Rules: Custom rules to block common attack patterns such as SQL injection and cross-site scripting (XSS). AWS Cognito Configuration. User Pools: Manage user sign-up, sign-in, and access control.

Benefits: Security: Protects the API from malicious attacks and unauthorized access. Efficiency: Lambda functions provide a cost-effective way to handle data processing tasks, scaling automatically with the load. Performance: API Gateway features like caching and rate limiting improve the overall performance and reliability of the API services.

FIG. 17—UI Examples for Segmentation and Audience Building—FIGS. 1700 and 17 present user interface (UI) examples designed for brands to segment customers and build targeted audiences based on data and insights derived from customer interactions.

1701: The UI displays a filterable interface allowing brands to segment and identify users according to various criteria, such as travel stages, locations, and relevant news or updates about these segments. This functionality enables brands to fine-tune their marketing strategies and tailor content to specific customer groups.

1702: This UI element aggregates the collected data and visually highlights correlations between different audiences. It showcases how various customer segments are related, helping brands to understand overlapping interests and behaviors. This insight assists in creating comprehensive audience profiles, enabling more effective targeting and personalized communication strategies.

These UI components facilitate a detailed analysis of customer data, aiding brands in crafting targeted marketing campaigns and enhancing customer engagement.

This process helps create a personalized experience based on the consumer's data inputs.

It is to be understood that the above description is intended to be illustrative, and not restrictive. Other implementations will be apparent to those of skill in the art upon reading and understanding the above description. The scope of the disclosure may, therefore, be determined with reference to the appended claims, along with the full scope of equivalents to which such claims are entitled.

In additional implementations, one or more processing devices for performing the operations of the above described implementations are disclosed.

As described above, the present disclosure provides a System and Method for Generating Personalized Travel Recommendations

This invention relates to a system and method for utilizing consented or aggregated customer data to generate personalized travel recommendations. More specifically, it concerns a system that takes various sources of customer data and integrates it with information on the supply and inventory of hotels, flights, activities, restaurants, and points of interest to suggest tailored travel plans.

The system comprises several key components:

Data Collection Module: This module is responsible for collecting customer data from various sources. These sources can include, but are not limited to, customer profiles, past travel history, preferences indicated through surveys, social media activity, and aggregated data from travel platforms. Importantly, all data collection is performed with the explicit consent of the customers or from aggregated datasets where individual identities are anonymized.

Data Processing Engine: Once collected, the data is processed to extract meaningful insights. This engine utilizes advanced data processing techniques such as machine learning algorithms, natural language processing, and statistical analysis to identify patterns and preferences in customer behavior.

Inventory Integration Module: This module integrates the processed customer data with the real-time supply and inventory data of various travel-related services. This includes databases of hotels, flights, activities, restaurants, and attractions. The integration ensures that the recommendations are based on up-to-date availability and pricing information.

Recommendation Algorithm: At the core of the system is a sophisticated recommendation algorithm. This algorithm considers the processed customer data alongside the integrated inventory data to generate personalized travel suggestions. It factors in parameters such as preferred travel dates, budget constraints, past preferences, and current trends to provide the most relevant and appealing options.

User Interface: The system presents the recommendations through an intuitive user interface, which can be accessed via a web application, mobile app, or integrated within other travel booking platforms. The interface allows users to view, customize, and book suggested travel plans seamlessly.

As described above, the present disclosure additionally provides a method for generating personalized travel recommendations that involves the following steps:

Data Acquisition: Collect customer data from consented sources or use anonymized aggregated datasets. This includes collecting information on customer preferences, past travel history, and demographic data.

Data Processing: Analyze the collected data using machine learning and data analytics techniques to identify patterns and insights relevant to the customer's travel preferences.

Inventory Integration: Integrate the processed data with real-time supply and inventory data from various travel service providers, ensuring the recommendations are based on the latest availability and pricing.

Algorithm Execution: Execute the recommendation algorithm, which matches the customer's preferences with the available inventory to generate personalized travel suggestions.

Recommendation Delivery: Present the recommendations to the user through a user-friendly interface, allowing for easy customization and booking of the travel plans.

These systems and methods may provide at least the following advantages:

Personalization: By leveraging detailed customer data, the system can provide highly personalized travel recommendations that cater to individual preferences and needs.

Real-Time Integration: The integration of real-time inventory data ensures that the recommendations are not only personalized but also practical and available.

Convenience: The user-friendly interface simplifies the process of planning and booking travel, enhancing the overall user experience.

Efficiency: The automated process reduces the time and effort required for customers to plan their trips, making it more efficient compared to traditional methods.

As described above, the present disclosure further provides a System and Method for Generating Personalized Travel Recommendations Powered by AI This invention relates to a system and method for utilizing consented or aggregated

customer data to generate personalized travel recommendations. More specifically, it concerns a system that takes various sources of customer data and integrates it with information on the supply and inventory of hotels, flights, activities, restaurants, and points of interest to suggest tailored travel plans. The system is powered by AI and can continuously learn and refine its suggestions through an interactive chat interface or through computer-vision LLMs.

The system comprises several key components:

Data Collection Module: This module is responsible for collecting customer data from various sources. These sources can include, but are not limited to, customer profiles, past travel history, preferences indicated through surveys, social media activity, and aggregated data from travel platforms. Importantly, all data collection is performed with the explicit consent of the customers or from aggregated datasets where individual identities are anonymized. Including also computer vision for photo analysis and tagging of preferences.

AI-Powered Chat Interface: The system features an AI-powered chat interface that interacts with customers to gather additional data, clarify preferences, and provide real-time suggestions. This chat interface is capable of ingesting new data continuously, learning from customer interactions, and refining future recommendations based on this ongoing learning process.

Data Processing Engine: Once collected, the data is processed to extract meaningful insights. This engine utilizes advanced data processing techniques such as machine learning algorithms, natural language processing, and statistical analysis to identify patterns and preferences in customer behavior.

Inventory Integration Module: This module integrates the processed customer data with the real-time supply and inventory data of various travel-related services. This includes databases of hotels, flights, activities, restaurants, and attractions. The integration ensures that the recommendations are based on up-to-date availability and pricing information.

Recommendation Algorithm: At the core of the system is a sophisticated recommendation algorithm. This algorithm considers the processed customer data alongside the integrated inventory data to generate personalized travel suggestions. It factors in parameters such as preferred travel dates, budget constraints, past preferences, and current trends to provide the most relevant and appealing options.

As discussed above, the present disclosure additionally teaches:

A method of transforming user's real-time first party or zero-party data into travel preferences for sharing with enterprise-wide brands and third-party systems, as depicted in FIG. 1.

In some implementations of a method, access to an individual's first party data is obtained through photo, calendar, email and location authorization on the user's device, followed by a determination of data relevance to travel preferences by the Legends database system.

A method to generate user or data interfaces tied to individual and aggregate travel preferences, stored in a data repository, as described in FIG. 1 at 160.

In some implementations of a method, the generation includes receipt of a token from user devices or brand consumer applications, as described at 110.

Some implementations of a method includes parsing of phone metadata, calendar and email, social media data, conversion and matching of coordinates, and the application of computer vision for travel preference analysis, as described at 120.

A method that employs generative AI models for predictive travel preferences and itineraries based on analyzed commonalities, as illustrated at 130.

In some implementations of a method, travel preferences are shared with users and third-party stakeholders through a Legends dashboard or API integration, as specified at 140.

A method that initiates by gaining access from user devices via third-party applications and returns value-based preferences through an API gateway, as characterized in FIG. 2.

A system architecture as depicted in FIG. 3, comprising client devices, a photo library, storage mechanisms, networks, servers, image processing pipelines, and algorithms designed to infer insights from photo library, location data, and application search history.

In some implementations of a system architecture, image and metadata upload initiates serverless event-driven compute services, triggering image processing and computer-vision based analysis workflows, as elaborated in architecture 300.

A mobile application user experience as represented in FIG. 4, enabling users to visualize TravelDNA™, manage authorizations, and leverage digital identity for third-party application authentication and rewards.

A geohashing and clustering algorithm as illustrated in FIG. 5, designed to convert latitude and longitude data into string representations, facilitating hierarchical image grouping based on geographic proximity.

A method to convert TravelDNA™ data into predefined elements for visualization, collectively forming a unique “planet”, which is subject to real-time updates and available as an NFT or Soulbound token, as detailed in FIG. 6.

A solution to address Cache Miss and improve visualization of pins on a user interface, utilizing caching strategies, Bloom filters, and read-through caching mechanisms, as portrayed in FIG. 7.

In some implementations, the Bloom filter assists in determining the presence or absence of pins at a location, facilitating quick and efficient map view displays.

A comprehensive dashboard system (800) designed to provide individual and aggregated insights into users' travel preferences, adaptable across both web-based platforms and mobile devices.

A top navigation bar (810) included in said dashboard (800) featuring multiple tabs that cater to varying functionalities such as Community Insights, User Insights, and Integrations.

An interface allowing interaction with an artificial intelligence system named “DiNA” (820) within the navigation bar, where DiNA offers itinerary or place recommendations based on historical user data.

A user detail section (830) present in the dashboard allowing en masse viewing or specific searching of user details for granular data analysis.

A geographical visualization module (840) in the dashboard enabling data filtering based on visited locations and suggesting potential future visitations.

A travel insights generation module (850) incorporated in the dashboard that delves deep into travel metrics, analyzing data points such as destination preferences and culinary choices.

An automatic segmentation module (860) integrated into the dashboard that represents customer segments based on their distinct travel inclinations.

An upcoming travel details section (870) in the dashboard that predicts itineraries based on a combination of AI-analyzed historical travels and present user preferences.

A scoring interface (880) in the dashboard provides insights into a user's purchase likelihood, brand loyalty, and adventurous spirit, with an associated subsection (880.1) delving deeper into individual and aggregate travel preferences.

A personalization section (890) at the end of the dashboard that visualizes aesthetic preferences from computer vision analysis and suggests marketing collateral, also integrating with marketing tools.

A dashboard system (900) dedicated to relaying preference insights for both individual users and third-party brands that interact with the functionalities illustrated in preceding figures.

An admin navigation bar (910) to the left of the dashboard offering streamlined access to various features like User Management, DiNA, and Settings.

An insights navigation bar (920) at the top of the dashboard that offers aggregated and specific user group insights, engagement metrics, and acquisition data.

An integrated search function (930) for pinpointing particular insights or users.

Insight modules including Audiences (940), Spending Patterns (950), Predictive Personalization Suggestions (960), Geographical Insights (970), Propensity Indexing (980), and Audience Population Visualization (990) for a comprehensive understanding of user behaviors and preferences.

An AI-assisted tool named “DiNA” which processes “TravelDNA™”-intricate travel preference data—to generate tailored travel itineraries.

A user interface (1010) allowing brands, operators, or individual travelers to input or sync their unique “TravelDNA™”.

A segment within the “DiNA” AI tool that curates and suggests travel itineraries (1020) based on the processed “TravelDNA™”.

A clearly structured interface in the “DiNA” tool for users to effortlessly understand suggested itineraries with details like activities and booking data.

An adaptive capability in “DiNA” to seamlessly integrate its itinerary suggestions into a brand's Point of Sale (POS) system or internal databases, ensuring real-time itinerary recommendations based on both “TravelDNA™” and available inventory.

A firewall 1110 designed to manage and enforce security for incoming and outgoing traffic.

Compute servers 1120 processing user requests and managing application logic.

An EKS cluster 1140 with a load balancer that distributes requests across multiple nodes 1150 for efficient workload management.

Microservices deployed on EKS cluster nodes, each serving specific functions and communicating with one another.

A cache system 1160, optimizing performance by storing frequently accessed data.

A read database 1170 prioritized for data retrieval operations.

A cluster database 1180 ensuring high availability and consistent data storage for microservices.

Two distinct VM environments 1210 and 1220 within a foundational physical server block.

VM 1210 containing application and API services in dedicated containers, ensuring lightweight virtualization and efficient deployment.

VM 1220 separately hosting notification and AI services within containers, enhancing isolation and preventing service interference.

A hypervisor 1230 managing resource allocation between VMs and abstracting physical server hardware resources.

The inclusion of a container engine within VMs, orchestrating individual containers and promoting application isolation.

A networking layer 1240, ensuring communication between containers within VMs and between separate VMs while maintaining network isolation.

The strategic combination of containerization and virtualization to optimize resource use, ensure service isolation, and streamline deployment processes.

User interaction with a web-based app to provide inputs, including photos and location data (1310, 1320).

Utilization of processors and GPUs to analyze the provided inputs with multithreading for enhanced efficiency (1330).

Temporary data storage in RAM post-processing, with local and flash memory options for both immediate and long-term storage needs (1340).

Presentation of processed insights and visualizations on the user's device, fostering user interaction with analysis results (1350).

Wireless communication capabilities, facilitating internet connectivity and interactions with external services (1360, 1370, 1380).

Local processing on the user's device, promoting quicker user feedback and less reliance on network connectivity.

Offline access to processed data, allowing user interactions even in low-connectivity scenarios.

Enhanced data privacy by prioritizing local storage, thereby reducing transfers to external servers.

User initiation of the data processing sequence using the User Mobile Device 1410 by activating a unique link.

Employment of a Mobile Browser 1420 to act as the primary interface, guaranteeing platform compatibility and mandatory HTTPS communication.

Seamless access to the Remote Device Photo Library 1430 upon obtaining user permissions via the web app.

Execution of a Server-Side Script on the Remote Config Server 1440 to securely obtain photo data.

Encrypted storage and transfer of photo data in the Legends Database 1450.

Deployment of Backend Processing Services 1460, capitalizing on multithreading, for efficient data computations.

Versatile delivery methods for the DNA data output 1470, including API integrations, email visualization, or assimilation into existing mobile apps.

Adaptability of the system to provide targeted insights for stakeholders, like travel agents, who lack dedicated applications but still require user preference data.

User initiation of the data processing sequence using the User Mobile Device 1410 by activating a unique link.

Employment of a Mobile Browser 1420 to act as the primary interface, guaranteeing platform compatibility and mandatory HTTPS communication.

Seamless access to the Remote Device Photo Library 1430 upon obtaining user permissions via the web app.

Execution of a Server-Side Script on the Remote Config Server 1440 to securely obtain photo data.

Encrypted storage and transfer of photo data in the Legends Database 1450.

Deployment of Backend Processing Services 1460, capitalizing on multithreading, for efficient data computations.

Versatile delivery methods for the DNA data output 1470, including API integrations, email visualization, or assimilation into existing mobile apps.

Adaptability of the system to provide targeted insights for stakeholders, like travel agents, who lack dedicated applications but still require user preference data.

It will be appreciated that while exemplary systems and methods may be described above in the context of the Travel and Hospitality industry, similar systems and methods may be utilized across other industries or sectors such as Financial Services, e-Commerce, Retail, Real-Estate, Transportation, Design and Fashion, for example.

What is claimed is:

1. A system comprising:
one or more processors configured to execute instructions and to:
collect customer data from at least one of a plurality of external data sources, where each external data source comprises customer data related to at least one of a customer profile, customer travel history, one or more customer-defined preferences, or digital activity;
process the collected customer data and extract one or more customer insights, wherein the collected customer data is processed utilizing patterns and preferences identified in the collected customer data using at least one of data parsing, mapping statistical analysis, a machine learning algorithm, natural language processing, or statistical analysis; and
delivering at least a portion of the extracted one or more customer insights to at least one of an internal dashboard for display or an external digital platform.

2. The system of claim 1, wherein the processor is further configured to:
generate one or more customer recommendations based on the extracted one or more customer insights and real-time supply and inventory data of travel services; and
at least one of:
deliver at least a portion of the one of more customer recommendations to at least one of the internal dashboard or the external digital platform; or
present at least a portion of the one or more customer recommendations on a user interface of a computing device.

3. The system of claim 2, wherein the real-time supply and inventory data comprises at least one of hotels, flights, activities, restaurants, experiences, events or attractions.

4. The system of claim 2, wherein the one or more customer recommendations are presented on the user interface of the computing device via at least one of a web application, a mobile app, or through integration with an external platform.

5. The system of claim 2, wherein the processor is further configured to:
interact with a customer via an artificial intelligence (AI) chat interface to at least one of collect additional customer data, clarify customer-defined preferences, or provide at least a portion of the one or more customer recommendations.

6. The system of claim 1, wherein the customer-defined preferences comprise at least one of preferred dates, budget constraints, past preferences, current trends, or other preferences or insights.

7. The system of claim 1, wherein at least a portion of the customer data is collected from photo metadata of photos from customer devices.

8. The system of claim 1, wherein at least a portion of the customer data is data collected from calendar data from customer devices.

9. The system of claim 1, wherein at least a portion of the customer data is at least one of location information from customer devices, data collected from email data from customer devices, or consumer-based applications on customer devices.

10. The system of claim 1, wherein the processor is further configured to:
generate and display on the user interface of the computing device a visualized planet comprising information related to collected customer data relating to a specific customer.

11. A computer-implemented method for generating personalized travel recommendations, the method comprising:
collecting, with one or more processors, customer data from a plurality of external data sources, wherein each data source comprises customer data related to at least one of a customer profile, customer travel history, one or more customer-defined preferences, or social media activity;
processing, with the one or more processors, the collected customer data and extracting, with the one or more processors, one or more customer insights, wherein the collected customer data is processed utilizing patterns and preferences identified in the collected customer data using at least one of data parsing, mapping statistical analysis, a machine learning algorithm, natural language processing, or statistical analysis; and
delivering, with the one or more processors, at least a portion of the extracted one or more customer insights to at least one of an internal dashboard for display or an external digital platform.

12. The method of claim 11, further comprising:
generating, with the one or more processors, one or more customer recommendations based on the extracted one or more customer insights and real-time supply and inventory data of a plurality of travel services; and
at least one of:
delivering, with the one or more processors, at least a portion of the one or more customer recommendations to at least one of the internal dashboard or the external digital platform; or
presenting, with the one or more processors, at least a portion of the one or more customer recommendations on a user interface of a computing device.

13. The method of claim 12, wherein the real-time supply and inventory data comprises at least one of hotels, flights, activities, restaurants, experiences, or attractions.

14. The method of claim 12, wherein the one or more customer recommendations are presented on the user interface of the computing device via at least one of a web application, a mobile app, or through integration with an external travel booking platform.

15. The method of claim 12, further comprising:
interacting with a customer via an artificial intelligence powered chat interface, with one or more processors, to at least one of collect additional customer data, clarify customer-defined preferences, or provide at least a portion of the one or more customer recommendations.

16. The method of claim 11, wherein the customer-defined preferences comprise at least one of preferred dates, expenditure, past preferences, current trends or other preferences or insights.

17. The method of claim 11, wherein at least a portion of the customer data is collected from photo metadata of photos from customer devices.

18. The method of claim 11, wherein at least a portion of the customer data is data collected from calendar data from customer devices.

19. The method of claim 11, wherein at least a portion of the customer data is at least one of location information from customer devices, data collected from email data from customer devices, or consumer-based applications on customer devices.

20. The method of claim 11, further comprising:
generating and displaying to a specific customer, with the one or more processors, a visualized planet comprising information related to collected customer data relating to the specific customer.
